(19) United States
(12) Patent Application Publication
(10) Pub. No.: US 2001/0056469 A1
(43) Pub. Date: Dec. 27, 2001

(54) Personal information providing system and personal information providing method

(75) Inventor: Takasi Oonuki, Tokyo (JP)

Correspondence Address: Paul-J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/883,419

(22) Filed: Jun. 18, 2001

(30) Foreign Application Priority Data
Jun. 21, 2000 (JP) 2000-186330

(51) Int. Cl. G06F 17/60; G06F 15/16

(52) U.S. Cl. 709/206; 705/10

(57) ABSTRACT

PC 5 inputs personal information on user A and transmits the inputted personal information to personal information server 1. Personal information server 1 registers the personal information on user A in personal information file 21 of user A. PC 5 transmits an electronic mail from user A to user B, generate recipient information describing information on user B based on the transmitted electronic mail and transmits the generated recipient information to personal information server 1. Personal information server 1 receives the recipient information and empowers user B described in the recipient information to refer to the personal information on user A. User B requests personal information server 1 to transmit the personal information on user A to user B. Personal information server 1 transmits the personal information on user A to user B if user B is empowered to refer to the personal information on user A.

### BACKGROUND OF THE INVENTION

1. Field of the Invention

The present invention relates to a personal information providing system. The present invention particularly relates to a personal information providing system and a personal information providing method for providing personal information data only to a requester with whom a user has communicated by electronic mail.

2. Description of the Prior Art:

In recent years, with the development of an electronic mail system through the Internet, parties hold business and personal communication with each other by electronic mail even if they are not aware of mutual detailed personal information such as faces and addresses.

There are two methods of transmitting personal information on a user to a person with whom the user has communicated only by electronic mail.

The first method is to distribute personal information on user A to a person who the user A wants to deliver his or her information as shown in FIG. 10.

In FIG. 10, it is assumed that user A, user B and user C communicate with one another by electronic mail. It is also assumed therein that the user A and user D do not communicate with each other by electronic mail.

If the user B or C wants personal information on the user A, the user B or C transmits an electronic mail for requesting the user A to provide the personal information on the user A \mathring{1} and \mathring{1}′ in FIG. 10). The user A transmits the personal information on the user A to the user B or C by electronic mail \mathring{2} and \mathring{2}′ in FIG. 10).

If the user D, with whom the user A has never communicated by electronic mail, transmits an electronic mail for requesting the user A to provide the personal information on the user A \mathring{1}″ in FIG. 10), the user A does not provide the personal information \mathring{2}″ in FIG. 10).

In this way, the user A can disclose the personal information on the user A only to the persons with whom the user A has ever communicated by electronic mail.

The other method is to register personal information on the user A with a personal information server connected to the Internet in advance and to allow other users who want the personal information on the user A to download the personal information from the personal information server as show in FIG. 11.

In FIG. 11, the personal information on the user A is registered with the personal information server connected to the Internet \mathring{1} in FIG. 11). The user B, C or D downloads the personal information on the user A from the personal information server \mathring{2} to \mathring{3}, \mathring{2}′ to \mathring{3}″ and \mathring{2}″ to \mathring{3}″ in FIG. 11).

This method is advantageous in that time and labor which the user A is required to transmit electronic mails and increased communication rates, both of which are the disadvantages of the former method, can be reduced.

The above-stated conventional techniques, however, have the following disadvantages.

In case of the first method, if the number of the other users who request the acquisition of the personal information on the user A increases, the time, labor and communication rates which the user A is required to have to transmit electronic mails increase accordingly. This is because the user A must transmit an electronic mail every time the other user requests the user A to do so.

The disadvantage of the second method is that personal information is provided even to the user D with whom the user A has never communicated by electronic mail. This is because all users including the users B, C and D can freely access the personal information server.

### SUMMARY OF THE INVENTION

It is, therefore, an object of the present invention to provide a personal information providing system and a personal information providing method capable of reducing time, labor and communication rates required to transmit personal information data and providing the personal information data only to a person with whom a user has communicated by electronic mail.

A personal information providing system according to the first invention of the present application is a personal information providing system for providing personal information on a user to a requester through the Internet, and is characterized by comprising means for providing the personal information data on the user only to the requester with whom the user has communicated by electronic mail.

According to a first aspect of the present invention, there is provided a personal information providing system for providing personal information on a user through the Internet, comprising: a provider for providing the personal information on the user only to one or more requesters with whom the user has communicated by electronic mail.

According to a second aspect of the present invention, there is provided a personal information providing system, comprising a user terminal and a personal information server, for providing personal information on a user through the Internet, wherein the user terminal comprises: personal information transmission means for transmitting the personal information on the user to the personal information server; electronic mail transmission means for allowing the user to create and transmit an electronic mail; recipient information generation means for transmitting to the personal information server recipient information on a recipient based on the electronic mail transmitted from the user; electronic mail reception means for allowing the user to receive the electronic mail; and personal information acquisition means for allowing a recipient who has been received an electronic mail to request personal information on a sender of the electronic mail, for acquiring the personal information on the sender from the personal information server, and for displaying the acquired personal information, and wherein the personal information server comprises: personal information registration means for receiving the personal information on the user from the user terminal, and for registering the received personal information with a personal information file; empowering means for receiving recipient information from the user terminal and for empowering the recipient who is described in the recipient information to refer to the personal information on the user; and personal information providing means for transmitting the personal information on the user to the recipient if the recipient requesting the personal information on the user is empowered to refer to the personal information on the user.

In the above personal information providing system, the user terminal may comprise means for generating cancellation information describing information on a person being forbidden, and for transmitting the generated cancellation information to the personal information server; the personal information server may comprise means for receiving the cancellation information, and for canceling power of a person described in the cancellation information to refer to the personal information on the user.

In the above personal information providing system, the recipient information generation means may be provided with a exclusion file for registering at least an electronic mail address of a recipient for whom recipient information shall not be generated, and the recipient information means may not generate the recipient information if the mail address of the recipient of the transmitted electronic mail is included in the exclusion file.

According to a third aspect of the present invention, there is provided a personal information providing method for providing personal information on a user through the Internet, comprising a step of: providing the personal information data on the user only to one or more requesters with whom the user has communicated by electronic mail.

According to a fourth aspect of the present invention, there is provided a personal information providing method for providing personal information on a user through the Internet, comprising the steps of: making the user register the personal information with a personal information server; transmitting an electronic mail created by the user to a recipient, generating recipient information describing information on the recipient based on the transmitted electronic mail, transmitting the generated recipient information to the personal information server; making the personal information server receive the recipient information, and empower the recipient described in the recipient information to refer to the personal information on the user; making the recipient of the electronic mail transmitted from the user receive the electronic mail; making the recipient request the personal information server to transmit the personal information on the user; making the personal information server examine whether the recipient is empowered to refer to the personal information on the user, and transmit the personal information on the user to the recipient if the recipient is empowered; and making the recipient refer to the received personal information on the user.

The above personal information providing method may further comprise a step of: making the personal information server cancel power of a person to refer to the personal information on the user in response to a cancellation instruction from the user.

The above personal information providing method, may further comprise a step of: failing to generate the recipient information if the mail address of the recipient of the transmitted electronic mail is included in an exclusion file for registering at least an electronic mail address of a recipient for whom recipient information shall not be generated.

### BRIEF DESCRIPTION OF THE DRAWINGS

FIG. 1 is a block diagram showing the constitution of one embodiment of the present invention;

FIG. 2 shows an example of a personal information file group;

FIG. 3 shows an example of a user management file;

FIG. 4 shows an example of the constitution of an electronic mail;

FIG. 5 shows an example of the constitution of a recipient information mail;

FIG. 6 is an explanatory view for the operation of the embodiment of the present invention;

FIG. 7 is a flow chart of operation for updating the user management file by the recipient information mail;

FIG. 8 shows an example of the updated user management file;

FIG. 9 is a flow chart of operation for acquiring personal information;

FIG. 10 shows an example of a conventional method; and

FIG. 11 shows another example of the conventional method.

### DESCRIPTION OF THE EMBODIMENT OF THE INVENTION

The present invention provides a constitution capable of reducing time, labor and communication rates required to transmit personal information data such as user's photograph, address and age and providing the personal information data only to a person with whom the user has communicated by electronic mail.

The embodiment of the present invention will be described hereinafter with reference to the drawings.

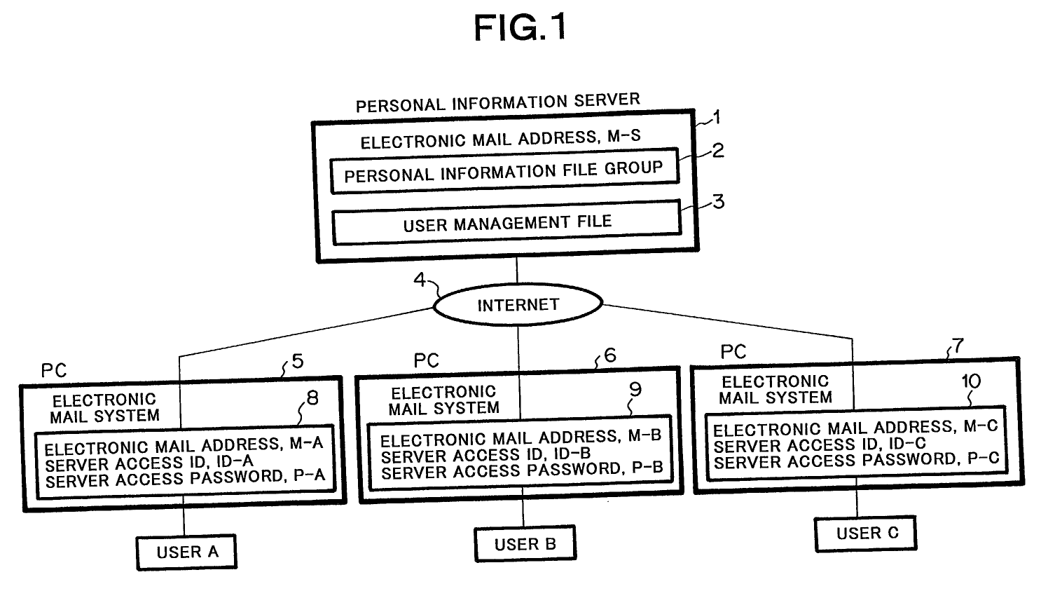

Referring to FIG. 1, a personal information providing system according to the present invention comprises a personal information server 1, a PC 5 which a user A uses, a PC 6 which a user B uses, a PC 7 which a user C uses and the Internet 4 mutually connecting the preceding constituent elements.

The personal information server 1 is an information processor for managing personal information on the users A to C. A personal information file group 2 which is a collection of personal information files for the respective users and a user management file 3 for managing the users are present in the personal information server 1. In addition, the personal information server 1 is given an electronic mail address for receiving a recipient information mail 12 as shown in FIG. 5. As can be seen from FIG. 1, the electronic mail address of the personal information server 1 is “M-S” in this embodiment.

The personal information server 1 has the following functions:

(1) To receive personal information on the users A to C from the PC's 5 to 7, respectively, and to register the received personal information with the respective personal information files.

(2) To receive address information from the PC's 5 to 7, to empower recipients described in the address information to refer to personal information on the users, and to add the recipients to “a personal information file reference permitted person ID list” in the user management file 3.

(3) If there is a personal information request, to check whether a requester who issues the request is empowered to refer to the personal information on the user using “the personal information file reference permitted person ID list” in the user management file 3 and to transmit the personal information on the user if the requester is empowered.

The PC's 5 to 7 are user terminals for the users A to C to access the personal information server 1 or the like through the Internet, which are information processors such as personal computers. Each of the users A to C is given an ID, a password and an electronic mail address for utilizing the personal information server 1. Electronic mail systems 8 to 10 which the users A to C use are installed into the PC's 5 to 7, respectively. The ID's, passwords and electronic mail addresses of the users A to C are recorded on these electronic mail systems 8 to 10, respectively. Referring to FIG. 1, for example, the electronic mail system 10 records ID-C, P-C and M-C, as the ID, the password and the electronic mail address of the user C, respectively.

Each of the PC's has the following functions:

(1) To input personal information on the corresponding user A, B or C and to transmit the inputted personal information to the personal information server 1.

(2) To create and transmit an electronic mail.

(3) To create recipient information, on which information on a recipient is described, based on the transmitted electronic mail, and to transmit the created recipient information to the personal information server 1.

(4) To receive an electronic mail.

(5) To request the personal information server 1 to transmit personal information on the sender of the electronic mail which the user receives, to acquire the personal information from the personal information server 1 and to display the acquired personal information on a screen.

Next, the personal information file group 2 will be described. The personal information file group 2 consists of personal information files of the respective users.

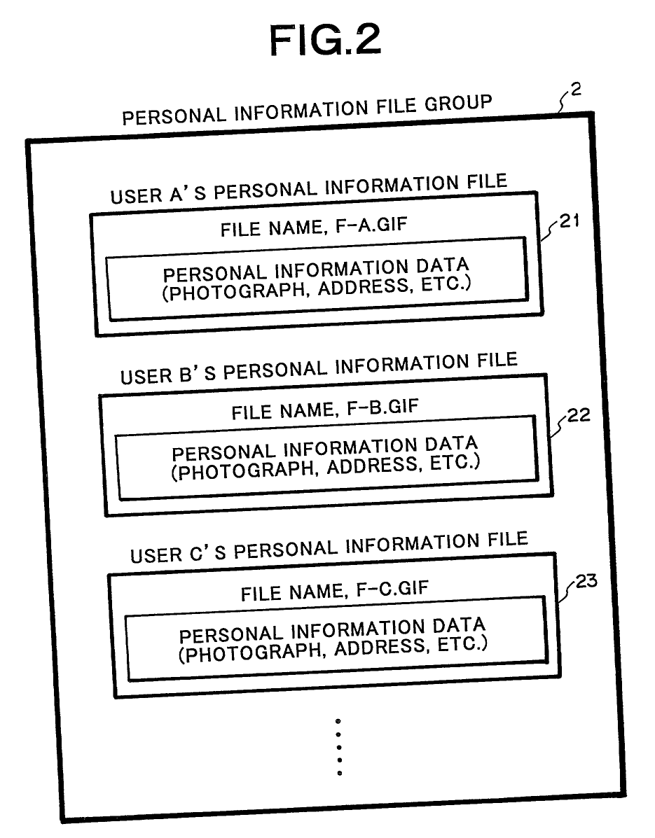

Referring to FIG. 2, the personal information file group 2 includes the personal information file 21 of the user A, the personal information file 22 of the user B and the personal information file 23 of the user C. Data such as user's photograph and address is recorded in each personal information file. Each personal information file is given a file name, i.e., the personal information file of the user A is named “F-A.gif”, the personal information file of the user B is named “F-B.gif” and the personal information file of the user C is named “F-C.gif”.

Next, the user management file 3 will be described. The user management file 3 manages the users of the personal information server 1.

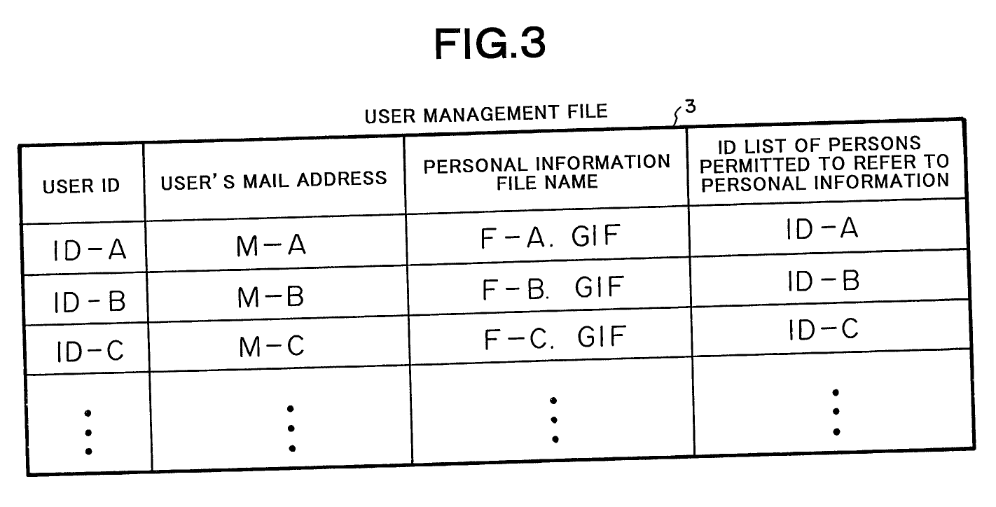

Referring to FIG. 3, the personal management file 3 consists of the ID's, electronic mail addresses and personal information file names of the users as well as a user ID list of users permitted to refer to the personal information files. The user management file 3 manages the users A to C.

The constitution of an electronic mail will be described.

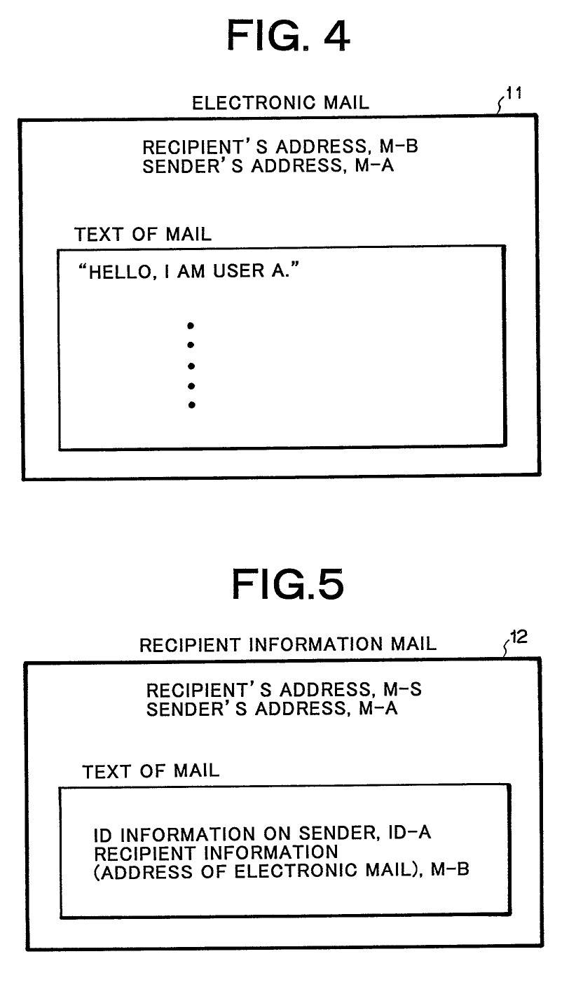

Referring to FIG. 4, the contents of an electronic mail 11 which the user A transmits to the user B is shown by way of example. The electronic mail 11 consists of the mail address of the user B who is a recipient, the mail address of the user A who is a sender and the text of the mail.

The constitution of a recipient information mail will be described.

Referring to FIG. 5, a recipient information mail 12 which is automatically created by the electronic mail system 8 of the PC 5 which the user A uses based on the contents of the electronic mail 11 sent from the user A to the user B, is shown by way of example. The recipient information mail 12 consists of the mail address of the personal information server 1 which is the recipient of the recipient information mail 12, the mail address of the user A who is the sender of the mail 12, the ID and recipient information (the mail address of the user B who is the recipient of the electronic mail 11) of the user A who is the sender.

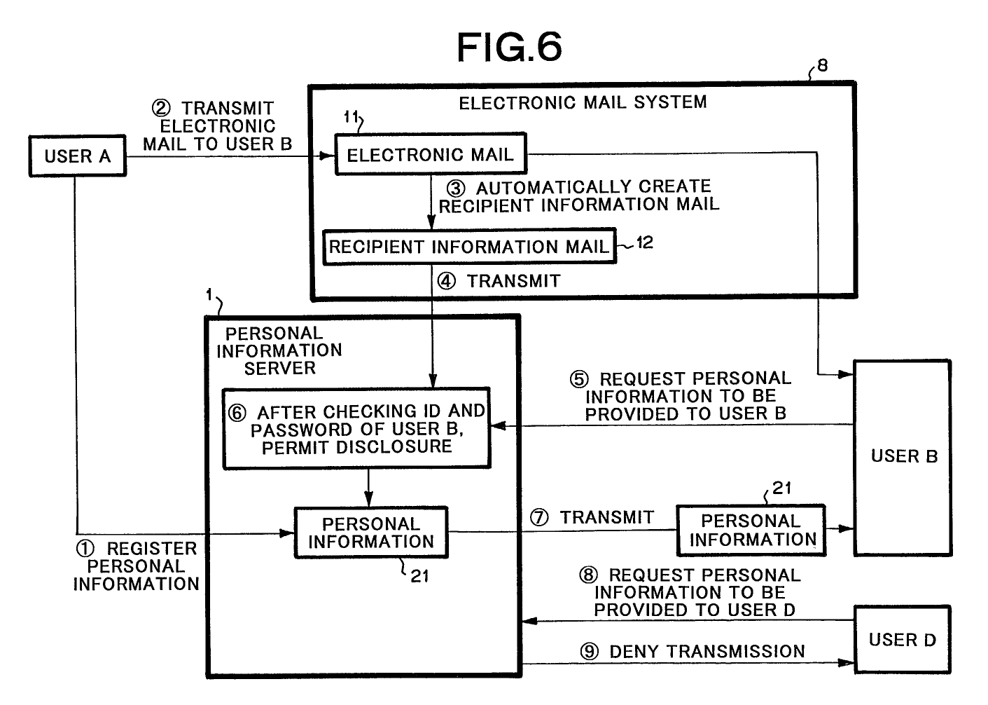

The operation of this embodiment of the present invention will be described hereinafter in detail with reference to FIGS. 6 to 9.

It is assumed that the personal information files 21 to 22 of the users A and B, respectively, are registered in advance with the personal information server 1 connected to the Internet.

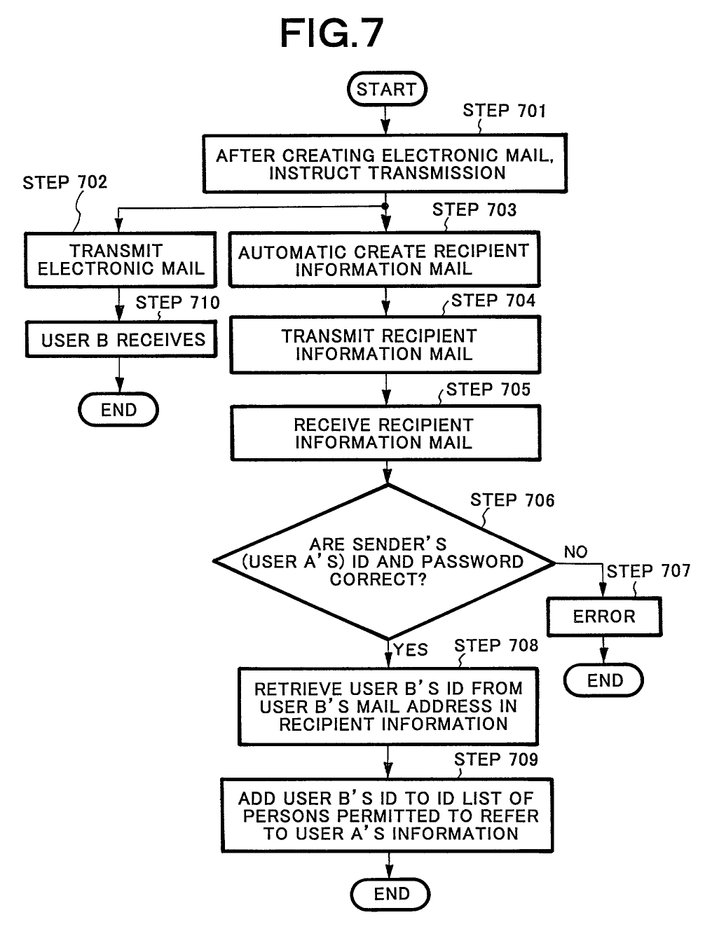

First, referring to FIG. 7, a flow of updating the user management file 3 by the recipient information mail will be described.

(1) The user A creates an electronic mail 11 addressed to the user B by means of the electronic mail system 8 and instructs the electronic mail system 8 to transmit the electronic mail 11 (in a step 701).

(2) The electronic mail system 8 transmits the electronic mail 11 to the user B, automatically creates the recipient information mail 12 based on the content of the electronic mail 11 and transmits the recipient information mail 12 to the personal information server 1 (in steps 702 to 704).

(3) When receiving the recipient information mail 12, the personal information server 1 checks whether the ID and mail address of the user A, who is the sender, are correct using the user management file 3 (in steps 705 to 706).

(4) If not correct, the personal information server 1 processes the mail 12 as an error (in a step 707). The processing goes to the following steps only if correct.

(5) Based on the mail address of the user B recorded on the recipient information mail 12, the ID of the user B is extracted from the user management file 3 (in a step 708).

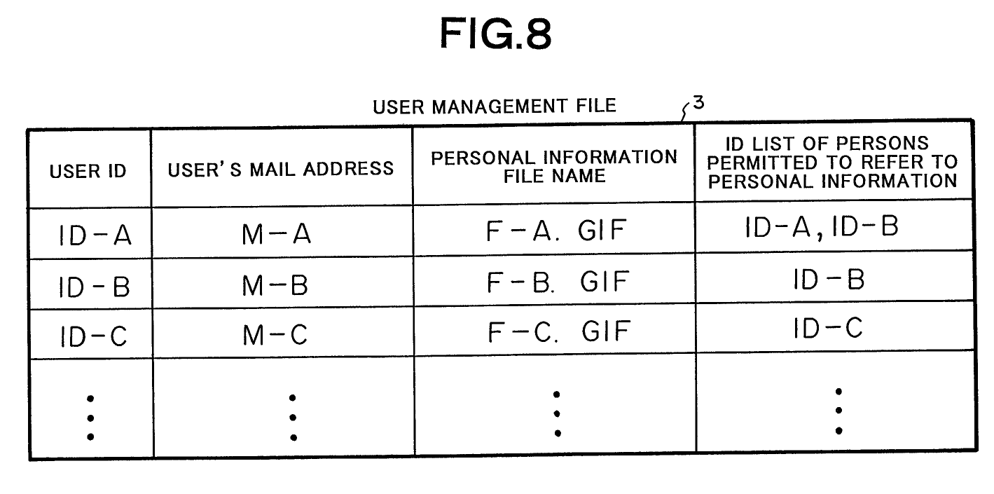

(6) The ID of the user B is added to the ID list of persons permitted to refer to information on the user A in the user management file 3 (in a step 709). FIG. 8 shows the contents of the updated user management file 3. Now, the user B is empowered to refer to the personal information file 21 (file name “F-A.gif”) of the user A.

(7) Separately from the operation of the personal information server 1, the user B receives the electronic mail 11 transmitted from the user A (in a step 710).

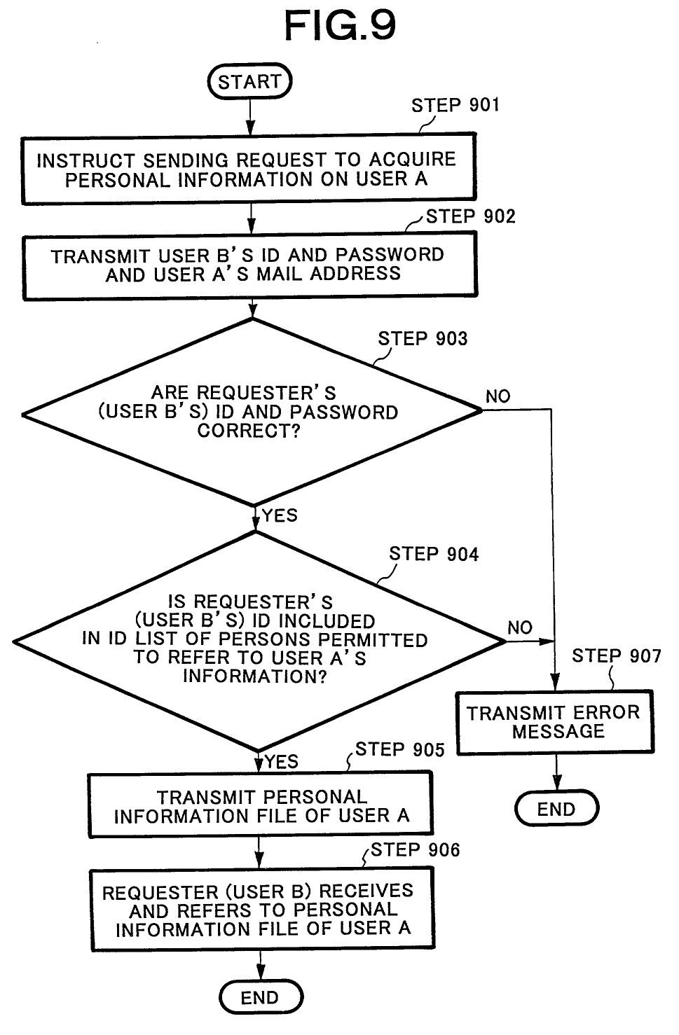

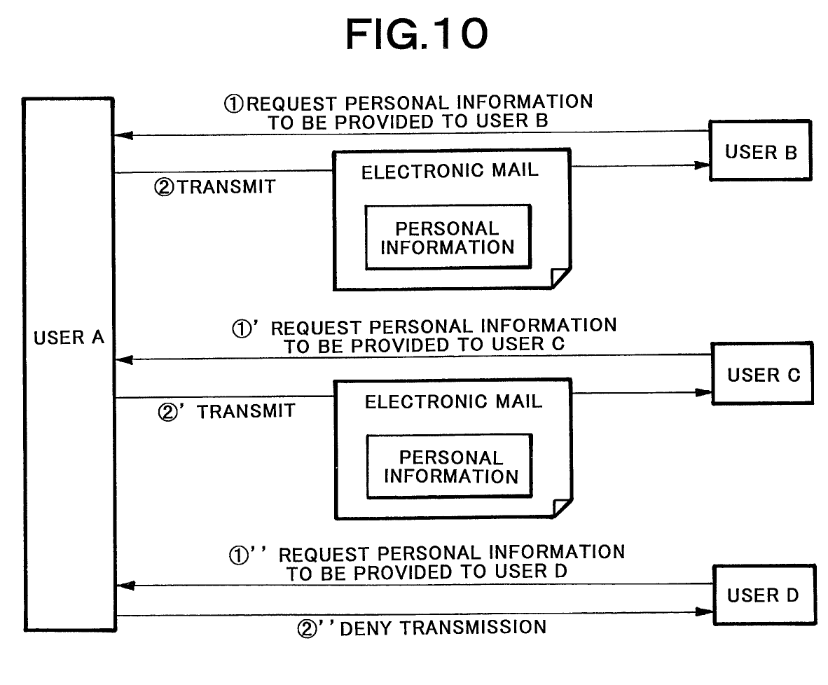

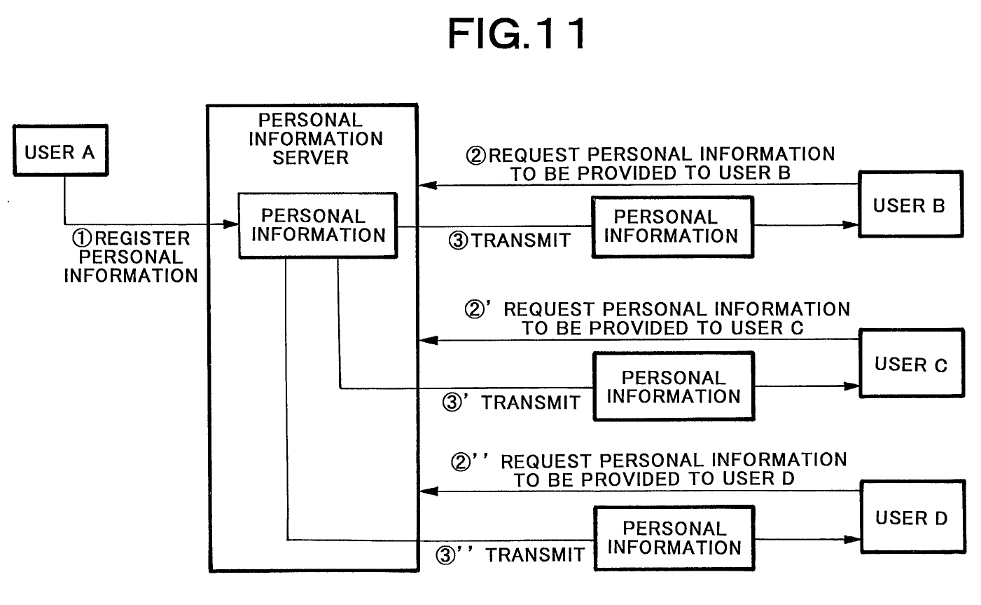

Next, referring to FIG. 9, a flow of acquiring personal information will be described while taking a case where the user B refers to the personal information file 21 of the user A, as an example.

(1) The user B instructs the electronic mail system 9 to acquire personal information on the user A (in a step 901). At this time, the user B designates the mail address of the user A.

(2) The electronic mail system 9 accesses the personal information server 1 through the Internet 4 and transmits the ID and password of the user B and the mail address of the user A to the personal information server 1 (in a step 902).

(3) The personal information server 1 examines whether the ID and password of the user B are correct using the user management file 3 (in a step 903).

(4) If not correct, the personal information server 1 transmits an error message to the electronic mail system 9 of the user B (in a step 907).

(5) If correct, the personal information server 1 examines whether the ID of the user B is recorded on the ID list of persons permitted to refer to the personal information on the user A. If not recorded, the personal information server 1 transmits an error message to the electronic mail system 9 of the user B (in a step 907). If recorded, the personal information server 1 transmits the personal information file 21 of the user A to the electronic mail system 9 of the user B (in a step 905).

(6) The electronic mail system 9 of the user B receives the personal information file 21 of the user A and displays the received personal information file 21 on a screen, to allow the user B to refer to the file 21 (in a step 906).

In this way, it is possible to reduce time, labor and communication rates required to transmit personal information on a user and to provide the personal information on the user only to a person with whom the user has communicated by electronic mail.

In the above-stated embodiment, if an electronic mail is transmitted, recipient information is created and the ID list of persons permitted to refer to personal information in the user management file is updated based on the recipient's mail address in the recipient information, thereby making it possible for the user who receives the electronic mail to refer to the personal information on the person who transmitted the electronic. Alternatively, if an electronic mail is received, sender information may be created and the ID list of persons permitted to refer to personal information in the user management file may be updated based on the mail address of the sender in the sender information, thereby making it possible for the person who transmits the electronic mail to refer to the personal information on the user who receives the electronic mail.

Furthermore, in the above-stated embodiment, the personal information data is transmitted after whether the recipient was registered with the user management file is examined while referring to the user management file using the recipient's mail address described in the recipient information received and the user ID of the recipient is added to the ID list of persons permitted to refer to the personal information file of the user who transmitted the electronic mail. Alternatively, the mail address of the recipient described in the received recipient information may be added to the list of persons permitted to refer to the personal information file of the user who transmitted the electronic mail, the personal information on the user may be transmitted to the requester if the mail address of the requester is registered. In the latter case, the list of persons admitted to refer to the personal information file is managed based not on the ID's of the users but on the mail addresses of the users, whereby it is possible to construct a system permitting even persons who do not use the personal information server to refer to the personal information on the users.

Moreover, means for allowing the PC's 5 to 7 to generate cancellation information describing information on person being forbidden and for transmitting the generated cancellation information to the personal information server, and means for allowing the personal information server 1 to receive the cancellation information and for canceling the power of a person permitted to refer to the personal information on the user described in the cancellation information may be added to the embodiment stated above. By doing so, it is possible to cancel a permission to refer to personal information afterward.

Additionally, a exclusion file for registering the mail address of a recipient for whom recipient information is not generated and means for not generating recipient information if the mail address of the recipient of the electronic mail transmitted is included in the exclusion file may be added to the embodiment stated above. By doing so, recipient information is not generated for a person excluded in advance and it is possible not to permit the person to refer to the personal information on the user.

Furthermore, a recipient information file showing a list of persons for whom recipient information has been generated and means for not regenerating recipient information for the persons registered with the recipient information file may be added to the embodiment stated above. By doing so, it is possible to avoid transmitting repeated recipient information to the personal information file.

The first advantage of the present invention is that time, labor and communication rates required to a user to distribute personal information can be reduced.

This is because means for registering personal information with the personal information server connected to the Internet and for allowing a user who wants the personal information to acquire the personal information from the personal information server via the Internet are provided.

The second advantage of the present invention is that it is possible to prevent a person, with whom a user has not communicated by electronic mail, from acquiring the personal information on the user.

This is because means for checking whether or not a requester is empowered to acquire the personal information on the user if the personal information on the user is requested by the requester, is provided.

What is Claimed is:

1. A personal information providing system for providing personal information on a user through the Internet, comprising:
a provider for providing the personal information on the user only to one or more requesters with whom the user has communicated by electronic mail.

2. A personal information providing system, comprising a user terminal and a personal information server, for providing personal information on a user through the Internet, wherein
said user terminal comprises:
personal information transmission means for transmitting the personal information on the user to the personal information server;
electronic mail transmission means for allowing said user to create and transmit an electronic mail;
recipient information generation means for transmitting to the personal information server recipient information on a recipient based on the electronic mail transmitted from said user;
electronic mail reception means for allowing said user to receive the electronic mail; and
personal information acquisition means for allowing a recipient who has been received an electronic mail to request personal information on a sender of the electronic mail, for acquiring the personal information on the sender from said personal information server, and for displaying the acquired personal information, and wherein
said personal information server comprises:
personal information registration means for receiving the personal information on said user from said user terminal, and for registering the received personal information with a personal information file;
empowering means for receiving recipient information from said user terminal and for empowering the recipient who is described in said recipient information to refer to the personal information on said user; and
personal information providing means for transmitting the personal information on said user to said recipient if said recipient requesting the personal information on said user is empowered to refer to the personal information on said user.

3. A personal information providing system according to claim 2, wherein
said user terminal further comprises means for generating cancellation information describing information on a person being forbidden, and for transmitting the generated cancellation information to said personal information server;
said personal information server further comprises means for receiving said cancellation information, and for canceling power of a person described in said cancellation information to refer to the personal information on said user.

4. The personal information providing system according to claim 2, wherein
said recipient information generation means is provided with a exclusion file for registering at least an electronic mail address of a recipient for whom recipient information shall not be generated, and wherein
said recipient information means does not generate said recipient information if the mail address of the recipient of said transmitted electronic mail is included in said exclusion file.

5. The personal information providing method for providing personal information on a user through the Internet, comprising a step of:
providing the personal information data on the user only to one or more requesters with whom the user has communicated by electronic mail.

6. A personal information providing method for providing personal information on a user through the Internet, comprising the steps of:
making the user register the personal information with a personal information server;
transmitting an electronic mail created by said user to a recipient,
generating recipient information describing information on the recipient based on said transmitted electronic mail,
transmitting the generated recipient information to said personal information server;
making said personal information server receive said recipient information, and empower the recipient described in said recipient information to refer to the personal information on said user;
making the recipient of the electronic mail transmitted from said user receive said electronic mail;
making said recipient request said personal information server to transmit the personal information on said user;
making said personal information server examine whether said recipient is empowered to refer to the personal information on said user, and transmit the personal information on said user to the recipient if the recipient is empowered; and
making said recipient refer to the received personal information on said user.

7. The personal information providing method according to claim 6, further comprising a step of:
making said personal information server cancel power of a person to refer to the personal information on said user in response to a cancellation instruction from said user.

8. The personal information providing method according to claim 6, further comprising a step of:
failing to generate said recipient information if the mail address of the recipient of said transmitted electronic mail is included in an exclusion file for registering at least an electronic mail address of a recipient for whom recipient information shall not be generated.
